(19) United States
(12) Patent Application Publication
(10) Pub. No.: US 2007/0111603 A1
(43) Pub. Date: May 17, 2007

(54) Memory card connector

(75) Inventor: Hsu-Fen Wang, Taipei (TW)

Correspondence Address: BRUCE H. TROXELL, SUITE 1404, 5205 LEESBURG PIKE, FALLS CHURCH, VA, 22041, US

(73) Assignee: Advanced Connectek Inc.

(21) Appl. No.: 11/448,025

(22) Filed: Jun. 7, 2006

(30) Foreign Application Priority Data
Nov. 11, 2005 (TW) 094219602

(51) Int. Cl. H01R 24/00

(52) U.S. Cl. 439/630

(57) ABSTRACT

The present invention relates to a memory card connector with a latching mechanism, it is to dispose the latching mechanism in the rotary slide memory card connector to limit the horizontal displacement of the metal shell of the memory card connector so as to secure and prevent the metal shell from shifting to a rotating position. The latching mechanism is consisted of an elastic clipping member on the metal shell and a fastening member arranged on the insulative housing, the elastic clipping member has a convex portion and the fastening member has a limiting portion relative to the elastic clipping member. After the convex portion is shifted horizontally across the limiting portion, the limiting portion thus will limit the horizontal shift of the metal shell, and the metal shell will be retained on the limiting portion within a definite pressure scope, so as to secure the connecting stability of the memory card connector.

### BACKGROUND OF THE INVENTION

1. Field of the Invention

The present invention relates to a memory card connector, and more particularly to a memory card connector with a latching mechanism which can limit the horizontal displacement of the metal shell of the memory card connector to secure the metal shell not to be shifted to the rotatable position.

2. Description of Related Art

Recently, the metal shell applied in the memory card connector is mostly adopted in rotary slide mode, i.e. the metal shell can be rotated to open, and in this state the memory card can be inserted in or taken out. When the metal shell is rotated to close, then the metal shell can be slid forward or backward to make the metal shell not to be rotated to open any more. In this art, a guarding plate is disposed on the metal shell, when the metal shell is horizontally shifted, the guarding plate will be clasped with the insulative housing to make the metal shell not to be rotated to open, i.e. the metal shell has a fixing effect in rotary shift, thereby to secure the memory card connector in connecting state.

Taiwan Patent No. M277159 is a utility model patent employing the above art, furthermore, this patent improves the defects of the above art, and it also increases the fixing effect in the horizontal displacement of the metal shell. A side edge of the metal shell extends a matching member, which has a latching portion, and the insulative housing has a notch for clasping the latching portion, thereby, when the metal shell is shifted horizontally, it can achieve a fixing effect by the interfering force between the notch and the latching portion to restrict the metal shell.

Such a design certainly makes the connecting state of the memory card connector more stable, but the above patent still has space for improving, especially the above notch is dented on the insulative housing directly, therefore the notch is identical with the insulative housing in material, after being continuous use for a while, the notch will be deformed or worn away due to rubbing with the latching portion. When the notch is deformed or worn away, the latching effect becomes very poor, which will result in the connecting state of the memory card becoming unstable. Because of the above defects, the existing memory card connector still needs to be improved.

### SUMMARY OF THE INVENTION

It is a main object of the present invention to provide a memory card connector with a latching mechanism, which can increase the stability of the metal shell in horizontal fixing position to make the metal shell not apt to be displaced horizontally.

It is another object of the present invention to provide a memory card connector with a latching mechanism, in which the latching mechanism can remain in perfect using state after a time period of use to prevent the memory card connector from becoming unstable.

To achieve the above objects, the memory card connector with a latching mechanism according to the present invention comprises a metal shell, an insulative housing, a plurality of conductive terminals and a plurality of fastening members, wherein the conductive terminals are fixed in the insulative housing, the fastening members are arranged on two sides of the insulative housing, the fastening members each has a plurality of fixing portions extended outward from the lower side of the insulative housing for fastening the insulative housing to a circuit board by soldering or surface mount technology (SMT) and the like. The metal shell is bent downward at both ends, and extending outward two axle portions. The insulative housing has two bearing portions at the positions relative to the axle portions, the bearing portions are elongated concave grooves disposed on two side surfaces of the insulative housing in horizontal direction, which makes the metal shell to be rotated on the bearing portion of the insulative housing through the axle portion. At the same time, when the metal shell is rotated and closed on the insulative housing, the metal shell can be shifted horizontally on the bearing portion through the axle portion. Besides, the metal shell has at least a clasping portion, and the insulative housing has a blocking portion relative to the clasping portion, after the metal shell is rotated and closed on the insulative housing, the vertical position of the blocking portion is higher than that of the clasping portion, which makes the clasping portion to be shifted horizontally to the lower side of the blocking portion. After the clasping portion is shifted to the lower side of the blocking portion, the blocking portion thus limits the clasping portion to move upward freely, i.e. the metal shell can't be rotated upward.

The above memory card connector is a rotary slide memory card connector, the above structures may have been disclosed in the prior arts, but the art of the present invention is characterized in that the metal shell includes at least an elastic clipping member, the distal end of the elastic clipping member has a downward projected convex portion, and the fastening member has a limiting portion on the position relative to the elastic clipping member.

Therefore, the elastic clipping member and the limiting portion form a latching mechanism, after the metal shell is rotated and closed on the insulative housing and when the metal shell is shifted horizontally along the bearing portion, the convex portion of the elastic clipping member will be shifted across the limiting portion. When the convex portion is shifted across the limiting portion, the limiting portion thus provides a resistance to make the metal shell be retained on the limiting portion if it doesn't surpass a definite pressure scope, so as to secure the memory card connector in perfect connecting state.

The above and other objects, features and advantages of the present invention will become apparent from the following detailed description taken with the accompanying drawings.

### BRIEF DESCRIPTION OF THE DRAWINGS

FIG. 1 is an exploded perspective view of a preferred embodiment of the present invention;

FIG. 2 is an assembled perspective view of the preferred embodiment of the present invention in open state;

FIG. 3 is another assembled perspective view of the preferred embodiment of the present invention in close state;

FIG. 4 is a side view showing the using state of the preferred embodiment of the present invention; and

FIG. 5 is another side view showing the using state of the preferred embodiment of the present invention.

### DETAILED DESCRIPTION OF THE PREFERRED EMBODIMENTS

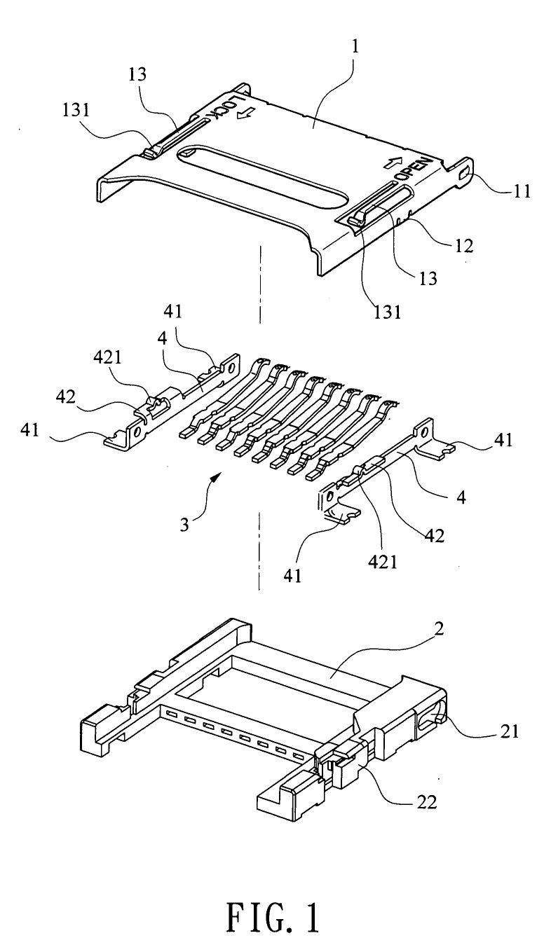

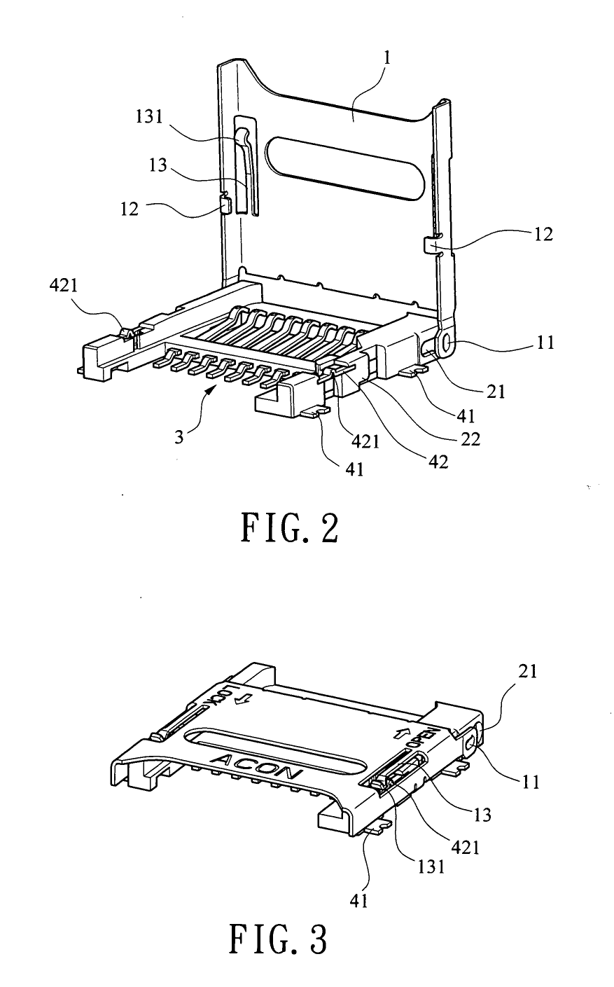

Refer to FIGS.1 and 2, which show a preferred embodiment of the present invention, the memory card connector of the present embodiment comprises a metal shell 1, an insulative housing 2, a plurality of conductive terminals 3 and two fastening members 4. The multiple conductive terminals 3 are fixed in the insulative housing 2. The two fastening members 4 are arranged on two sides of the insulative housing 2, each fastening member 4 has a plurality of fixing portions 41 extended outward from the lower side of the insulative housing 2 for fastening the insulative housing 2 to a circuit board (not shown) by soldering or surface mount technology (SMT) and the like. The metal shell 1 is bent downward at both ends respectively, and extending outward two axle portions 11. The insulative housing 2 has two bearing portions 21 at the positions relative to the axle portions 11, each bearing portion 21 is an elongated concave groove disposed on two side surfaces of the insulative housing 2 in horizontal direction, which makes the metal shell 1 to be rotated on the bearing portion 21 of the insulative housing 2 through the axle portion 11. At the same time, when the metal shell 1 is rotated and closed on the insulative housing 2, the metal shell 1 can be shifted horizontally on the bearing portion 21 through the axle portion 11. Besides, the metal shell 1 has at least a clasping portion 12, and the insulative housing 2 has a blocking portion 22 relative to the clasping portion 12, after the metal shell 1 is rotated and closed on the insulative housing 2, the vertical position of the blocking portion 22 is higher than that of the clasping portion 12, which makes the clasping portion 12 can be shifted horizontally to the lower side of the blocking portion 22. After the clasping portion 12 is shifted to the lower side of the blocking portion 22, the blocking portion 22 thus limits the clasping portion 12 to move upward freely, i.e. the metal shell 1 can't rotate upward.

In the present embodiment, the metal shell 1 has two elastic clipping members 13 disposed on the left and right sides thereof, on the distal end of the elastic clipping member 13 having a downward projected convex portion 131, which is formed by bending a downward V-shaped portion at the distal end of the elastic clipping portion 13. The two fastening members 4 each includes a limiting portion 42 relative to the convex portion 131, the limiting portion 42 has an upward projected rib portion 421, which is formed by bending a upward V-shaped portion in the middle of the limiting portion 42.

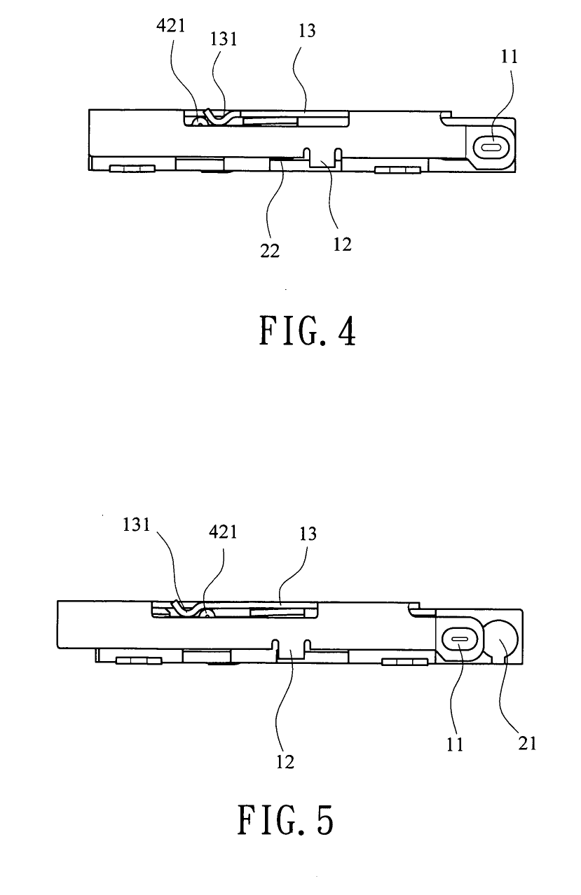

Please refer to FIGS. 3 and 4, the convex portion 131 of the elastic clipping member 13 and the rib portion 421 of the limiting portion 42 form a latching mechanism, after the metal shell. 1 is rotated and closed on the insulative housing 2 and when the metal shell 1 is shifted along the bearing portion 21 horizontally, the convex portion 131 of the elastic clipping member 13 can be shifted across the rib portion 421 of the limiting portion 42. When the convex portion 131 is shifted across the rib portion 421, the rib portion 421 provides a resistance to limit the convex portion 131 of the metal shell 1 on the back of the rib portion 421 if the pressure imposed on the metal shell 1 doesn't surpass a definite scope, i.e. it can make the metal shell 1 be retained on the limiting portion 42, so as to secure the clasping portion 12 of the metal shell 1 not to be shifted out of the blocking portion 22 of the insulative housing 2, therefore the metal shell 1 can't be rotated upward, so as to keep the connector in firmly connecting state.

The advantages of the present invention lie in that the latching mechanism is formed respectively by the elastic clipping portion 13 of the metal shell 1 and the limiting portion 42 of the fastening member 4, it is independent from the insulative housing 2, therefore it could achieve a perfect management in quality control independently; besides, if the fastening members 4 are made of a metal, the latching effect of the metal shell 1 can be further improved and can go through a long time using test.

In the embodiment of the present invention, the limiting portion 42 also could be a concave portion dented downwardly on the fastening member 4 to be used for limiting the horizontal displacement of the convex portion 131 of the elastic clipping portion 13.

While the invention herein disclosed has been described by means of specific embodiments, numerous modifications and variations could be made thereto by those skilled in the art without departing from the scope and spirit of the invention set forth in the claims.

What is claimed is:

1. A memory card connector with a latching mechanism, comprising a metal shell, an insulative housing, a plurality of conductive terminals and a plurality of fastening members; wherein said metal shell includes at least an elastic clipping member, the distal end of said elastic clipping member having a downward projected convex portion, and said fastening member having a limiting portion relative to said elastic clipping member, thereby said elastic clipping member and said limiting portion form a latching mechanism, after said metal shell is shifted to be located, then the metal shell is retained in place if a definite pressure is imposed, so as to secure said memory card connector in connecting state.

2. The memory card connector with a latching mechanism of claim 1, wherein said elastic clipping member is disposed on one of the two sides of said metal shell, and said fastening member with a limiting portion is disposed on said insulative housing on the same side relative to said elastic clipping member.

3. The memory card connector with a latching mechanism of claim 1, wherein said elastic clipping members are disposed on both sides of the said metal shell, and said fastening members with a limiting portion are disposed on both sides of said insulative housing.

4. The memory card connector with a latching mechanism of claim 1, wherein said convex portion is bent a downward V-shaped portion from the distal end of said elastic clipping member.

5. The memory card connector with a latching mechanism of claim 1, wherein said limiting portion of said fastening member has an upward projected rib portion.

6. The memory card connector with a latching mechanism of claim 1, wherein said limiting portion of said fastening member has a downward dented rib portion.
